(19) United States
(12) Patent Application Publication
(10) Pub. No.: US 2022/0030369 A1
(43) Pub. Date: Jan. 27, 2022

(54) VIRTUAL MICROPHONE CALIBRATION BASED ON DISPLACEMENT OF THE OUTER EAR

(71) Applicant: Facebook Technologies, LLC, Menlo Park, CA (US)

(72) Inventors: Pablo Francisco Faundez Hoffmann, Kenmore, WA (US); Peter Gottlieb, Seattle, WA (US); Morteza Khaleghimeybodi, Bothell, WA (US)

(21) Appl. No.: 16/934,673

(22) Filed: Jul. 21, 2020

(51) Int. Cl. H04R 29/00; G06F 3/16; H04R 3/04

(52) U.S. Cl. CPC H04R 29/004; H04R 3/04; G06F 3/165

(57) ABSTRACT

An audio system calibrates a virtual microphone using displacement of an outer ear of a user. A transducer presents audio content to the user. One or more sensors monitor displacement of a portion of a pinna of the user. The displacement may be caused in part by the presented audio content. The audio system estimates a sound pressure at an entrance to an ear canal of the user based on the monitored displacement of the portion of the pinna, generates a sound filter accordingly, and adjusts audio content using the sound filter. The transducer presents the adjusted audio content to the user, thereby improving the user's auditory experience.

### FIELD OF THE INVENTION

The present disclosure generally relates to an audio system in a headset, and specifically relates to virtual microphone calibration based on displacement of an outer ear of a user of the headset.

### BACKGROUND

A headset may provide audio content to a user. Conventionally, to calibrate the headset to provide spatialized sound to the user, microphones are placed in ear canals of the user, usually at the entrance to the ear-canal. Sounds captured by the microphones are used to calibrate and equalize the output of the system and then head-related transfer functions (HRTFs) are used for delivering 3D spatialized sounds. The device may use the HRTFs to generate audio content which is presented via one or more speakers to provide spatialized audio content. To ensure high reproduction quality, the one or more speakers may be equalized at the same point at which the HRTFs were captured. However, using a microphone within the ear to calibrate the headset is not always practical or desired.

### SUMMARY

An audio system is described herein. The audio system is configured to calibrate a virtual microphone based on displacement of one or both ears of a user. For an ear of the user, the audio system produces a calibration signal (e.g., via transducers) and measures displacement of a portion of the ear (e.g., via displacement sensors) that may be caused in part due to the calibration signal. The audio system provides the displacement information as input to a model configured to output an estimated sound pressure at an entrance to an ear canal of the ear. Accordingly, the audio system can simulate how a virtual microphone at the entrance to the ear canal would detect audio content. In some embodiments, one or more of the audio system's displacement sensors are integrated into one or more of the audio system's transducers. For example, a cartilage conduction transducer (e.g., configured to present audio content via cartilage conduction) coupled to an ear of the user may include and/or be coupled to a displacement sensor that measures displacement of the ear when the cartilage conduction transducer vibrates the ear.

Audio content is presented, via one or more transducers, to the user. One or more sensors monitor displacement of at least a portion of a pinna of the user caused in part by the presented audio content. Sound pressure at an entrance to an ear canal of the user is estimated based on the monitored displacement of the portion of the pinna. A sound filter for the transducer is generated using the remotely estimated sound pressure at the entrance to the ear canal, and audio content is adjusted using the generated filter. Subsequently, the transducer presents the adjusted audio content to the user.

In some embodiments, an audio system that calibrates the virtual microphone is disclosed. The audio system includes a transducer, one or more sensors, and a controller. The transducer is configured to measure displacement of a portion of a pinna of the user caused by presented audio content. The controller is configured to estimate a sound pressure at an entrance to an ear canal of the user based on the monitored displacement of the portion of the pinna, generate a sound filter for the transducer using the estimated sound pressure, and adjust audio content using the generated filter. The controller instructs the transducer to present the adjusted audio content to the user.

### BRIEF DESCRIPTION OF THE DRAWINGS

FIG. 1A is a perspective view of a headset, implemented as an eyewear device, configured to calibrate a virtual microphone, in accordance with one or more embodiments.

FIG. 1B is a perspective view of a headset, implemented as a head-mounted display, configured to calibrate a virtual microphone, in accordance with one or more embodiments.

FIG. 2 is a side view of a portion of a headset configured to calibrate a virtual microphone, in accordance with one or more embodiments.

FIG. 3A is a block diagram of a cartilage conduction transducer configured to monitor displacement of an ear of a user with a capacitive displacement sensor, in accordance with one or more embodiments.

FIG. 3B is a block diagram of a cartilage conduction transducer configured to monitor displacement of an ear of a user with an optical encoder, in accordance with one or more embodiments.

FIG. 4 is a block diagram of an audio system, in accordance with one or more embodiments.

FIG. 5 is a flowchart of a process for calibrating a virtual microphone, in accordance with one or more embodiments.

FIG. 6 is a block diagram of an example artificial reality system environment, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

An audio system calibrates a “virtual microphone” positioned at an entrance to an ear canal of an ear of a user. In effect, the virtual microphone is a simulated presence of a microphone at the entrance to the ear canal by characterizing how sound is detected at the entrance to the ear canal. The audio system plays a calibration signal via transducers and subsequently measures displacement of at least a portion of the user's user caused in part by the calibration signal. The audio system provides the displacement information as input to a model, which outputs an estimated sound pressure at the entrance to the ear canal of the user's ear. In some embodiments, the audio system calibrates a virtual microphone for both ears of the user. The audio system may use the estimated sound pressure at the entrance to the ear canal to generate sound filters and adjust audio content for the user using the sound filters.

A headset may present audio content to the user. To improve the user's auditory experience, conventional audio systems require the user to place a target microphone at the entrance to the ear canal of the ear. Accordingly, the audio system characterizes how sound is perceived at the entrance to the ear canal. However, this conventional calibration technique is often impractical or uncomfortable for the user. In contrast, the audio system described herein eliminates the need for conventional calibration techniques, calibrating a virtual microphone at the entrance to the ear canal of one or both of the user's ears.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a headset (e.g., head-mounted display (HMD) and/or near-eye display (NED)) connected to a host computer system, a standalone headset, a mobile device or computing system, or any other hardware platform capable of providing artificial reality content to one or more viewers.

### System Overview

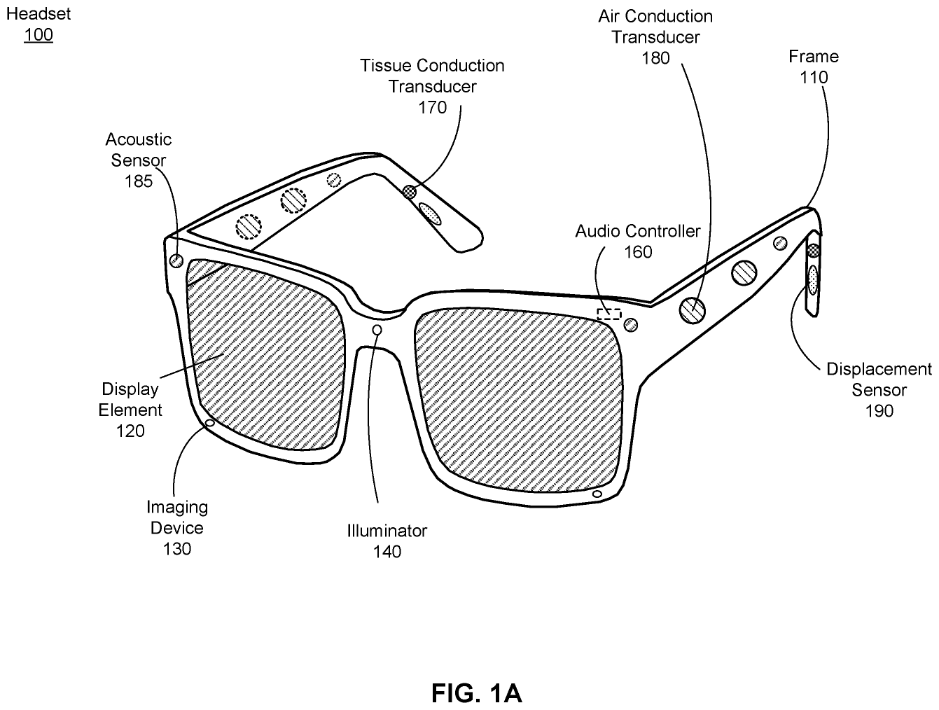

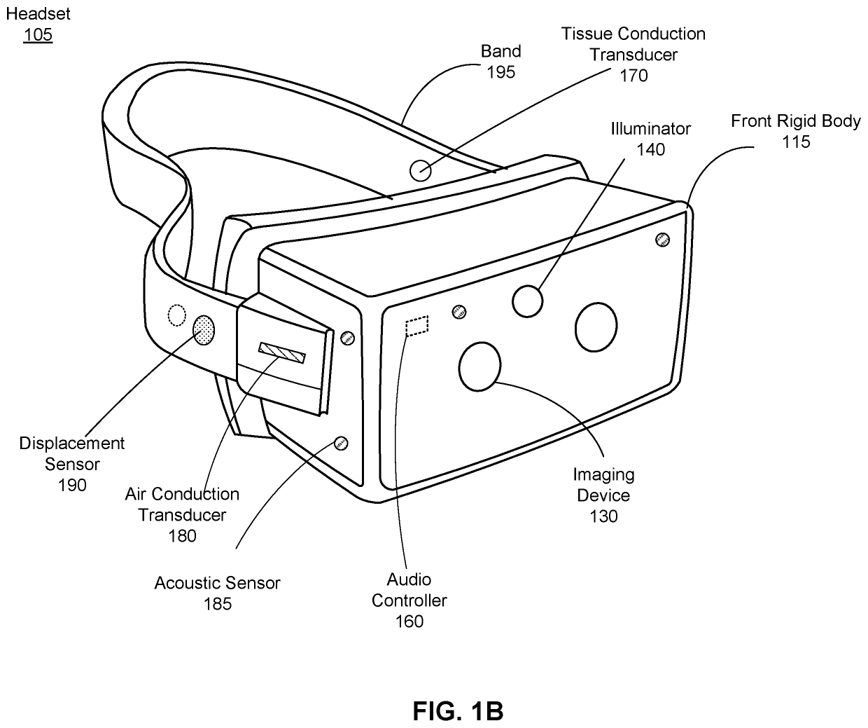

FIG. 1A is a perspective view of a headset 100, implemented as an eyewear device, configured to calibrate a virtual microphone, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), and an audio system. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof. In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof In some embodiments, the sensor array (discussed below) generates measurement signals in response to motion of the headset 100 and tracks the position (e.g., location and pose) of the headset 100 within the room.

The audio system presents audio content to the user. The audio system includes a transducer array, a sensor array, and an audio controller 160. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes one or more transducers, including one or more tissue conduction transducers 170 and one or more air conduction transducers 180. In some embodiments, one or more of the transducers of the transducer array are be enclosed within the frame 110. In some embodiments, the headset 100 includes one or more transducers along and/or at an end of each arm of the frame 110. Accordingly, a plurality of transducers may improve directionality of presented audio content.

The one or more tissue conduction transducers 170 generate sound via tissue conduction. Each of the tissue conduction transducers 170 may be, for example, a cartilage conduction transducer and/or a bone conduction transducer. The tissue conduction transducers 170 couple to and directly vibrate tissue (e.g., bone and/or cartilage) of the user to generate acoustic waves perceived by at least one inner ear of the user. Accordingly, the user perceives the acoustic waves as sound. Each tissue conduction transducer 170 is positioned proximate to and/or in contact with tissue of an ear of the user (e.g., at a back of a pinna). In some embodiments, the headset 100 includes at least one tissue conduction transducer 170 at each of the user's ears. The number and/or locations of the tissue conduction transducers 170 may be different from what is shown in FIG. 1A.

The one or more air conduction transducers 180 generate sound via air conduction. The air conduction transducers 180 may be, for example, speakers that generates acoustic waves, perceived by at least one inner ear of the user as sound. In some embodiments, a plurality of air conduction transducers 180 are positioned on and/or along the frame 110 of the headset 100. The number and/or locations of the air conduction transducers 180 may be different from what is shown in FIG. 1A.

The sensor array of the headset 100 measures various parameters. The sensor array includes one or more acoustic sensors 185 and one or more displacement sensors 190. In some embodiments, the sensor array includes additional sensors in addition to and/or instead of those described herein.

The one or more acoustic sensors 185 detect sounds within the local area of the headset 100. The acoustic sensors 185 capture sounds emitted from one or more sound sources in the local area (e.g., a room), including the transducer array. Sounds detected by the acoustic sensors 185 are used to calibrate a “virtual” microphone at an entrance to an ear canal of the user. A virtual microphone is not a physical device—but instead is a virtual device that simulates the presence of a microphone and accordingly can be used by the headset 100 to characterize how sound is perceived at the simulated position of the virtual microphone. For example, the headset 100 may be able to better present spatialized audio content based on the calibrated virtual microphone at the entrance to the ear canal.

Each acoustic sensor is configured to detect sound and convert the detected sound into an electronic format (analog or digital). The acoustic sensors 185 may be acoustic wave sensors, microphones, sound transducers, or similar sensors that are suitable for detecting sounds. In some embodiments, the acoustic sensors 185 may be placed on an exterior surface of the headset 100, placed on an interior surface of the headset 100, separate from the headset 100 (e.g., part of some other device), or some combination thereof. The number and/or locations of acoustic sensors 185 may be different from what is shown in FIG. 1A. For example, the number of acoustic detection locations may be increased to increase the amount of audio information collected and the sensitivity and/or accuracy of the information. The acoustic detection locations may be oriented such that the virtual microphone is calibrated to account for sounds in a wide range of directions surrounding the user wearing the headset 100.

The one or more displacement sensors 190 measure displacement of portions of the user's ears. For example, the displacement sensors 190 may each couple to one of the user's ears. After audio content is produced by the one or more transducers, each portion of the ears may vibrate in part due to the audio content. Accordingly, the displacement sensors 190 measure the displacement caused in part by the vibration of the portion of the ear. In some embodiments, the headset 100 may designate more than one displacement sensor 190 for each ear of the user. Each of the displacement sensors 190 may be configured to measure displacement of various portions of the user's ears. The displacement sensors 190 may be an optical displacement sensor, an inertial measurement unit, an accelerometer, a velocity meter, a gyroscope, or another suitable type of sensor that detects motion, or some combination thereof.

The displacement sensors 190 may be positioned in other locations than those shown in FIG. 1A. In some embodiments, the displacement sensors 190 measure displacement of a portion of a facial tissue of the user caused by vibration. For example, the displacement sensor 190 may measure displacement of a portion of the user's temple, forehead, and so on. In some embodiments, one or more of the displacement sensors 190 may be coupled to a portion of the headset 100 that makes contact with a nose of the user. These displacement sensors 190 accordingly measure displacement of facial tissue caused by bone conduction from the user's voice.

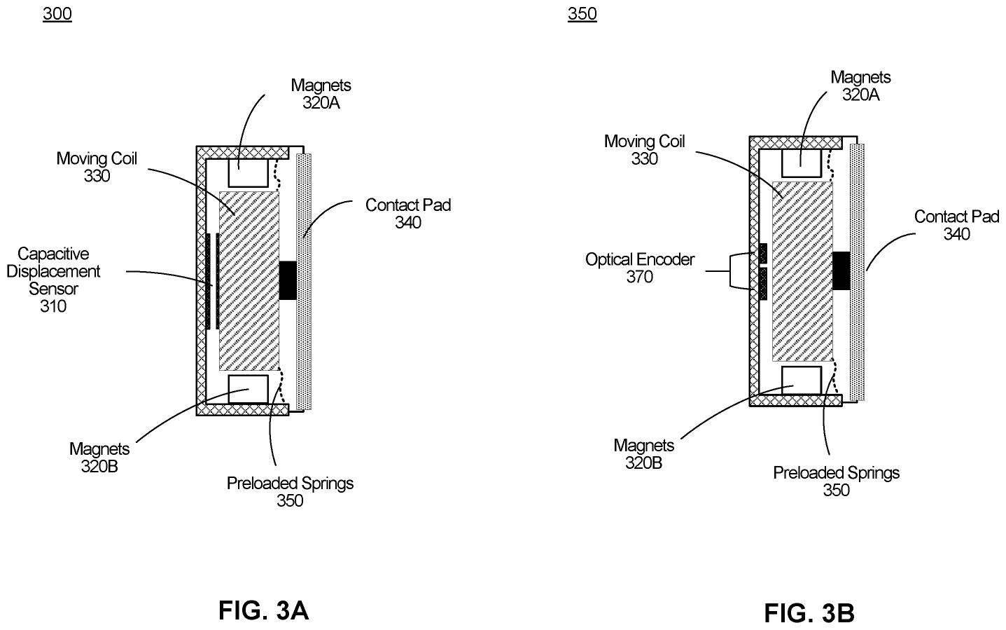

In some embodiments, at least one of the displacement sensors 190 is part of and internal to a tissue conduction transducer. For example, the displacement sensor 190 may measure displacement of a portion of the user's ear that is coupled to a tissue conduction transducer. Embodiments of cartilage conduction transducers that include displacement sensors are described in more detail with respect to FIGS. 3A-B.

The audio controller 160 processes information from the sensor array and instructs the transducer array to present audio content. In some embodiments, the audio controller 160 calibrates a virtual microphone at an entrance of the ear canal of the user's based on the measurements of the displacement sensors 190. The audio controller 160 may calibrate a virtual microphone for one or both ears of the user (e.g., at each entrance of the ear canal). For a given ear, the audio controller 160 takes, as input, the measurement of the displacement of at least a portion of that ear. A model executed by the audio controller 160 correlates the measured displacement information to an estimated sound pressure at an entrance to the ear canal of the ear using a functional mapping of measured displacement information to estimated sound pressure. Accordingly, the audio controller 160 outputs an estimated sound pressure at the entrance to the ear canal, based on which the audio controller 160 may generate and apply sound filters to audio content. For example, the sound filters may better spatialize the audio content, prevent sound leakage (e.g., by amplifying and/or attenuating some or all frequencies of the audio content), and improve intelligibility of the audio content (e.g., by enhancing frequencies that may be otherwise misheard by the user). Additionally, the user may experience improved audio quality and perceive the audio content as more natural. The audio controller 160 instructs the transducer array to present the resulting filtered audio content. In some embodiments, the audio controller 160 may comprise a processor and a computer-readable storage medium. In addition, the audio controller 160 may be configured to generate direction of arrival (DOA) estimates, generate acoustic transfer functions (e.g., array transfer functions and/or head-related transfer functions), track the location of sound sources, form beams in the direction of sound sources, classify sound sources, or some combination thereof.

FIG. 1B is a perspective view of a headset, implemented as a head-mounted display, configured to calibrate a virtual microphone, in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 195. The headset 105 includes many of the same components described above with reference to FIG. 1A, but modified to integrate with the HMD form factor. For example, the HMD includes a display assembly, a DCA, and an audio system. FIG. 1B shows a plurality of the imaging devices 130, the illuminator 140, the audio controller 160, the tissue conduction transducers 170, the air conduction transducers 180, the acoustic sensors 185, and the displacement sensors 190. Different components may be located in various locations, such as coupled to the band 195 (as shown), coupled to front rigid body 115, or may be configured to be inserted within the ear canal of a user.

### Headset for Calibrating a Virtual Microphone

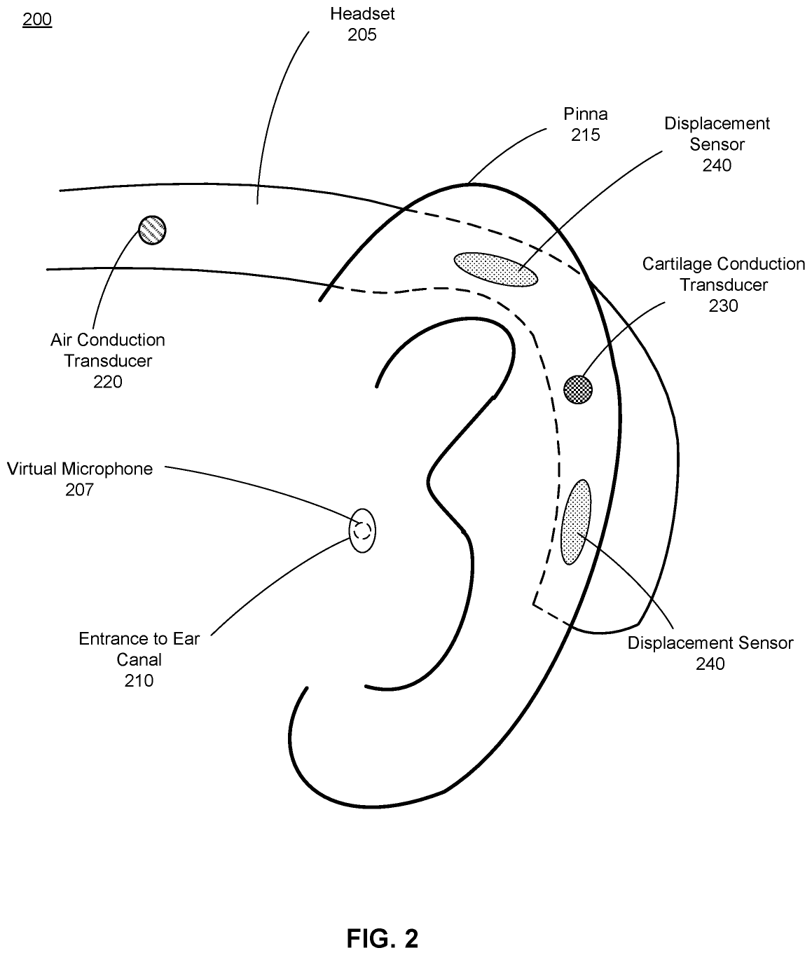

FIG. 2 is a side view 200 of a portion of a headset 205 configured to calibrate a virtual microphone 207, in accordance with one or more embodiments. The headset 205 simulates the presence of the virtual microphone 207 at an entrance to an ear canal 210 of an ear of the user. The virtual microphone 207 is used to characterize how audio content is perceived at the entrance to the ear canal 210. The portion of the headset 205 shown in FIG. 2 includes an air conduction transducer 220, a cartilage conduction transducer 230, and one or more displacement sensors 240. The headset 205 may be an embodiment of the headset 100 of FIG. 1A and accordingly may include components other than those shown herein. For example, the headset 205 may include a controller, a display assembly, and so on.

The air conduction transducer 220 may present audio content to the user. The air conduction transducer 220 may be a speaker that presents audio content via air conduction. In some embodiments, the air conduction transducer 220 is a component of a transducer array of the headset 205. The transducer array, in some embodiments, includes a plurality of air conduction transducers configured to provide audio content to one or both ears of the user.

The cartilage conduction transducer 230 may present audio content to the user via cartilage conduction. The cartilage conduction transducer 230 may be positioned directly and/or indirectly in contact with tissue of and/or proximate to the ear. The cartilage conduction transducer 230 vibrates the portion of the ear that is in contact with, thereby generating a range of acoustic pressure waves that are detected as sound by a cochlea of an inner ear of the user (not shown in FIG. 2). In FIG. 2, when the headset 205 is worn by the user, the cartilage conduction transducer 230 comes in contact with the pinna 210. In other embodiments, the cartilage conduction transducer 230 may be positioned to be in contact with a tragus of the ear, a lobule of the ear, some other part of the ear, or some combination thereof. In some embodiments, the cartilage conduction transducer 230 is a component of the transducer array of the headset 205. The transducer array, in some embodiments, includes a plurality of cartilage conduction transducers configured to provide audio content to one or both ears of the user.

The displacement sensors 240 measures displacement of a portion of the pinna 210. In some embodiments, one of the displacement sensor 240 couples to a portion of the back of the pinna 210. In other embodiments, at least one of the displacement sensors 340 couples to a top of the pinna 210. When the pinna 210 vibrates due to the audio content produced by the transducer 220 and/or the cartilage conduction of the cartilage conduction transducer 230, the displacement sensors 240 measures the displacement of the pinna 210. The displacement sensor 240 may be an acceleration sensor, an optical displacement sensor, or some combination thereof. In some embodiments, the displacement sensor 240 is integrated into and/or coupled to the cartilage conduction transducer 230. For example, the displacement sensor 240 may measure displacement of a portion of the user's ear that is coupled to the tissue conduction transducer. The is described in more detail with respect to FIGS. 3A-B.

In some embodiments (not shown), one or more displacement sensors measure the displacement of other portions of the user's face and/or ear that move and/or vibrate in response to audio content produced by the transducer 220 and/or cartilage conduction transducer 230. For example, a displacement sensor may be in contact with and measure the displacement of a portion of a temple, a forehead, and so on, of the user's face.

### Monitoring Displacement of an Ear Via a Cartilage Conduction Transducer

FIG. 3A is a block diagram of a cartilage conduction transducer 300 configured to monitor displacement of an ear of a user with a capacitive displacement sensor 310, in accordance with one or more embodiments. The cartilage conduction transducer 300 presents audio content to the user via cartilage conduction and is configured to measure displacement of a portion of an ear of the user. The cartilage conduction transducer 300 may be a component of a headset (e.g., the headset 205) and an embodiment of the cartilage conduction transducer 230 coupled with the displacement sensor 240. The cartilage conduction transducers 300 includes magnets 320A and 320B (collectively referred to as the magnets 320), a moving coil 330, a contact pad 340, preloaded springs 350, and the capacitive displacement sensor 310. The cartilage conduction transducer 300 may include other components than those shown in FIG. 3A.

The magnets 320 generate a magnetic field that causes the moving coil 330 to vibrate. The magnets 320 include soft and/or hard magnets. For example, the magnets 320A and 320B may be soft and hard magnets, respectively. A soft magnet may be made of steel and/or nickel plated, while a hard magnet may be a neodymium magnet and/or zinc plated. The cartilage conduction transducer 300 may include more magnets than those shown in FIGS. 3A-B.

The moving coil 330 vibrates in response to an input signal and due to the magnetic field generated by the magnets 320. When electrical current passes through, the moving coil 330 experiences Lorentz forces that cause the moving coil 330 to vibrate as per frequencies designated in the input signal. The moving coil 330 may be a printed circuit board (PCB), or another structure that is sufficiently rigid to receive the Lorentz forces. In some embodiments, the moving coil 330 may include flexible printed circuitry.

The contact pad 340 couples to a tissue of an ear of the user. To present audio content via cartilage conduction, the cartilage conduction transducer 300 vibrates tissue at and/or near the ear of the user (e.g., the pinna). The contact pad 340 comes in direct and/or indirect contact with the tissue that vibrates with the movement of the moving coil 330.

The preloaded springs 350 position the cartilage conduction transducer 300 to make contact with the tissue of the ear of the user. When the user wears a headset including the cartilage conduction transducer 300, the preloaded springs 350 are configured to position the cartilage conduction transducer 300 in contact with the user's ear at a nominal position. When the cartilage conduction transducer 300 is at the nominal position, the preloaded springs 350 may have a predictable response when vibrating against the tissue of the user's ear. When measured, the displacements of the preloaded springs 350 characterize the contact force from the cartilage conduction transducer 300 to the tissue of the ear. In some embodiments, the preloaded springs 350 may be used as an error detection mechanism. For example, when the preload of the preloaded springs 350 is beyond a threshold amount such that the cartilage conduction transducer 300 may not make contact with tissue of the ear of the user, the user may be notified that the headset needs to be repositioned.

The capacitive displacement sensor 310 measures a displacement of contact pad 340. The displacement may be due, in part, to vibrations of the moving coil 330 when the cartilage conduction transducer 300 presents audio content via cartilage conduction. The capacitive displacement sensor 310 accordingly measures displacement of the portion of the ear that the contact pad 340, and accordingly the cartilage conduction transducer 300,is coupled to. For example, the cartilage conduction transducer 300 may receive instructions (e.g., from a controller of a headset) to present audio content. The moving coil 330 vibrates, when presenting the audio content, such that it is displaced from its rest position. The displacement of the moving coil 330 changes a capacitance value, which is detected by the capacitive displacement sensor 310. In some embodiments, the capacitive displacement sensor 310 determines displacement of the pinna 210 caused by audio content presented by an air conduction transducer (e.g., the transducer 220). In some embodiments, the capacitive displacement sensor 310 is structured such that it includes two electrodes set a distance apart, forming a capacitor. When the moving coil 330 vibrates, the distance between the two electrodes of the capacitive displacement sensor 310 varies, thereby changing the capacitance. In other embodiments, the capacitive displacement sensor 310 is structured differently than what is described herein.

FIG. 3B is a block diagram of a cartilage conduction transducer 350 configured to monitor displacement of an ear of a user with an optical encoder 370, in accordance with one or more embodiments. The cartilage conduction transducer 350 is structurally and functionally similar to the cartilage conduction transducer 300, except that it includes the optical encoder 370 for measuring displacement of the user's ear instead of the capacitive displacement sensor 310. The optical encoder 370 may have a higher sensitivity, and therefore may be used to measure smaller magnitudes of displacement of the user's ear. In some embodiments, the cartilage conduction transducer 350 varies in structure and/or function from the cartilage conduction transducer 300

The optical encoder 370 measures a displacement of the contact pad 340 due to vibrations of the moving coil 330, when the cartilage conduction transducer 350 presents audio content via cartilage conduction. Similar to the capacitive displacement sensor 310, the optical encoder 370 can be used to determine a displacement of a portion of a tissue of an ear of the user caused by the cartilage conduction transducer 350 and/or an air conduction transducer. For example, the optical encoder 370 may be used to determine displacement of the pinna 210. In some embodiments, the optical encoder 370 includes a light source (e.g., an LED) and a mechanism (e.g., a shaft) that shifts light emitted by the light source when the moving coil 330 is vibrating. Accordingly, the optical encoder 370 monitors a position of the light due to the moving coil 330, thereby measuring the displacement of the portion of the ear that the cartilage conduction transducer 350 is coupled to.

### Audio System Overview

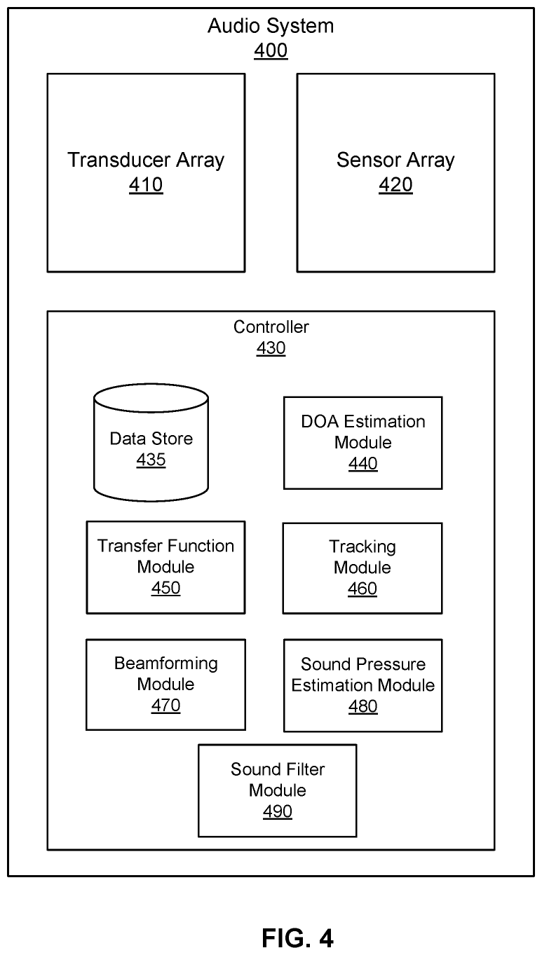

FIG. 4 is a block diagram of an audio system 400, in accordance with one or more embodiments. The audio system 400 provides audio content to a user. In some embodiments, the audio system 400 calibrates (1) a virtual microphone positioned at an entrance to an ear canal (e.g., the entrance to the ear canal 215) of a user's left ear; (2) a virtual microphone positioned at an entrance to an ear canal of the user's right ear, or (3) a virtual microphone positioned at respective entrances to the ear canals of the right and left ear. The audio system may adjust audio content for the user based in part on the calibrated virtual microphone(s). The audio system 400 may be a component of and/or coupled to a headset (e.g., the headsets 100, 105). The audio system 400 includes a transducer array 410, a sensor array 420, and a controller 430. In some embodiments, the audio system 400 includes additional components.

The transducer array 410 presents audio content to the user in accordance with instructions from the controller 430. The transducer array 410 includes one or more transducers that present audio content via air conduction (e.g., the air conduction transducer 220) and/or tissue conduction (e.g., the cartilage conduction transducer 230). The transducer array 410 may be configured to present audio content over a range of frequencies, such as 20 Hz to 20 kHz, generally around the average range of human hearing. In some embodiments, the transducer array 410 presents adjusted (e.g., filtered, augmented, amplified, or attenuated) audio content.

The sensor array 420 measures various parameters relating to the headset. The sensor array 420 includes one or more acoustic sensors (e.g., the acoustic sensor 185) and/or one or more displacement sensors (e.g., the displacement sensor 240). The acoustic sensors detect sounds from the local area, which is used to generate one or more virtual microphones for one or both ears of the user. The displacement sensors calibrate the generated virtual microphones, by measuring displacement of a portion of the user's ear (e.g., the pinna 210). The portion of the user's ear may vibrate and/or be displaced due to the audio content produced by the transducer array 410, which is measured by the displacement sensors of the sensor array 420. In some embodiments, at least one of the displacement sensors is integrated into a cartilage conduction transducer of the transducer array 410. The displacement sensors may be an optical displacement sensor, an inertial measurement unit, an accelerometer, a gyroscope, or another suitable type of sensor that detects motion, or some combination thereof.

In some embodiments, the sensor array 420 further includes one or more acoustic sensors (e.g., the acoustic sensor 185) configured to detect sound. The acoustic sensors may be configured to detect acoustic pressure waves from sound in a local area around the user and convert the detected acoustic pressure waves into an analog and/or digital format. The acoustic sensors may be, for example, microphones, accelerometers, another sensor that detects acoustic pressure waves, or some combination thereof.

The controller 430 processes data received from the sensor array 420 and instructs the transducer assembly 410 to present audio content, enabling the audio system 400 to calibrate a virtual microphone at an entrance to the user's ear canal. The audio controller 160 of FIG. 1 is an embodiment of the controller 430. The controller 430 includes a data store 435, a direction of arrival (DOA) estimation module 440, a transfer function module 450, a tracking module 460, a beamforming module 470, a sound pressure estimation module 480, and a sound filter module 490. In some embodiments, the controller 430 includes other modules and/or components than those described herein.

The data store 435 stores data relevant to the audio system 400. This includes, for example, the measured displacement information for one or both ears of the user, the calibration signal, the data on which the model is trained, the generated sound filters, some other information by the audio system 400, or some combination thereof. In addition, data in the data store 435 may include sounds recorded in the local area of the audio system 400, audio content, head-related transfer functions (HRTFs), transfer functions for one or more sensors, array transfer functions (ATFs) for one or more of the acoustic sensors, sound source locations, virtual model of local area, direction of arrival estimates, sound filters, and other data relevant for use by the audio system 400, or any combination thereof.

The DOA estimation module 440 is configured to localize sound sources in the local area based in part on information from the sensor array 420. Localization is a process of determining where sound sources are located relative to the user of the audio system 400. The DOA estimation module 440 performs a DOA analysis to localize one or more sound sources within the local area. The DOA analysis may include analyzing the intensity, spectra, and/or arrival time of each sound at the sensor array 420 to determine the direction from which the sounds originated. In some cases, the DOA analysis may include any suitable algorithm for analyzing a surrounding acoustic environment in which the audio system 400 is located.

For example, the DOA analysis may be designed to receive input signals from the sensor array 420 and apply digital signal processing algorithms to the input signals to estimate a direction of arrival. These algorithms may include, for example, delay and sum algorithms where the input signal is sampled, and the resulting weighted and delayed versions of the sampled signal are averaged together to determine a DOA. A least mean squared (LMS) algorithm may also be implemented to create an adaptive filter. This adaptive filter may then be used to identify differences in signal intensity, for example, or differences in time of arrival. These differences may then be used to estimate the DOA. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct path audio signal. Those bins having a portion of the direct-path signal may then be analyzed to identify the angle at which the sensor array 420 received the direct-path audio signal. The determined angle may then be used to identify the DOA for the received input signal. Other algorithms not listed above may also be used alone or in combination with the above algorithms to determine DOA.

In some embodiments, the DOA estimation module 440 may also determine the DOA with respect to an absolute position of the audio system 400 within the local area. The position of the sensor array 420 may be received from an external system (e.g., some other component of a headset, an artificial reality console, a mapping server, a position sensor, etc.). The external system may create a virtual model of the local area, in which the local area and the position of the audio system 400 are mapped. The received position information may include a location and/or an orientation of some or all of the audio system 400 (e.g., of the sensor array 420). The DOA estimation module 440 may update the estimated DOA based on the received position information.

The transfer function module 450 is configured to generate one or more acoustic transfer functions. Generally, a transfer function is a mathematical function giving a corresponding output value for each possible input value. Based on parameters of the detected sounds, the transfer function module 450 generates one or more acoustic transfer functions associated with the audio system. The acoustic transfer functions may be array transfer functions (ATFs), head-related transfer functions (HRTFs), other types of acoustic transfer functions, or some combination thereof. An ATF characterizes how the microphone receives a sound from a point in space.

An ATF includes a number of transfer functions that characterize a relationship between the sound source and the corresponding sound received by the acoustic sensors in the sensor array 420. Accordingly, for a sound source there is a corresponding transfer function for each of the acoustic sensors in the sensor array 420. And collectively the set of transfer functions is referred to as an ATF. Accordingly, for each sound source there is a corresponding ATF. Note that the sound source may be, e.g., someone or something generating sound in the local area, the user, or one or more transducers of the transducer array 410. The ATF for a particular sound source location relative to the sensor array 420 may differ from user to user due to a person's anatomy (e.g., ear shape, shoulders, etc.) that affects the sound as it travels to the person's ears. Accordingly, the ATFs of the sensor array 420 are personalized for each user of the audio system 400.

In some embodiments, the transfer function module 450 determines one or more HRTFs for a user of the audio system 400. The HRTF characterizes how an ear receives a sound from a point in space. The HRTF for a particular source location relative to a person is unique to each ear of the person (and is unique to the person) due to the person's anatomy (e.g., ear shape, shoulders, etc.) that affects the sound as it travels to the person's ears. In some embodiments, the transfer function module 450 may determine HRTFs for the user using a calibration process. In some embodiments, the transfer function module 450 may provide information about the user to a remote system. The user may adjust privacy settings to allow or prevent the transfer function module 450 from providing the information about the user to any remote systems. The remote system determines a set of HRTFs that are customized to the user using, e.g., machine learning, and provides the customized set of HRTFs to the audio system 400.

The tracking module 460 is configured to track locations of one or more sound sources. The tracking module 460 may compare current DOA estimates and compare them with a stored history of previous DOA estimates. In some embodiments, the audio system 400 may recalculate DOA estimates on a periodic schedule, such as once per second, or once per millisecond. The tracking module may compare the current DOA estimates with previous DOA estimates, and in response to a change in a DOA estimate for a sound source, the tracking module 460 may determine that the sound source moved. In some embodiments, the tracking module 460 may detect a change in location based on visual information received from the headset or some other external source. The tracking module 460 may track the movement of one or more sound sources over time. The tracking module 460 may store values for a number of sound sources and a location of each sound source at each point in time. In response to a change in a value of the number or locations of the sound sources, the tracking module 460 may determine that a sound source moved. The tracking module 460 may calculate an estimate of the localization variance. The localization variance may be used as a confidence level for each determination of a change in movement.

The beamforming module 470 is configured to process one or more ATFs to selectively emphasize sounds from sound sources within a certain area while de-emphasizing sounds from other areas. In analyzing sounds detected by the sensor array 420, the beamforming module 470 may combine information from different acoustic sensors to emphasize sound associated from a particular region of the local area while deemphasizing sound that is from outside of the region. The beamforming module 470 may isolate an audio signal associated with sound from a particular sound source from other sound sources in the local area based on, e.g., different DOA estimates from the DOA estimation module 440 and the tracking module 460. The beamforming module 470 may thus selectively analyze discrete sound sources in the local area. In some embodiments, the beamforming module 470 may enhance a signal from a sound source. For example, the beamforming module 470 may apply sound filters which eliminate signals above, below, or between certain frequencies. Signal enhancement acts to enhance sounds associated with a given identified sound source relative to other sounds detected by the sensor array 420.

The sound pressure estimation module 480 estimates a sound pressure at an entrance to an ear canal when audio content is played. Using a model, the sound pressure estimation module 480 characterizes how audio content is perceived at the entrance to the ear canal (e.g., predicting what a binaural microphone at the entrance to the ear canal would detect in response to audio content), thereby simulating a virtual microphone. The sound pressure estimation module 480 may instruct the transducer array 410 to play a calibration signal by air conduction and/or tissue conduction. The calibration signal may be audio content that produces acoustic waves perceivable by the user, such as a note played for an amount of time, a piece of music, and so on. The sound pressure estimation module 480 uses displacement information (e.g., as measured by one or more displacement sensors of the sensor array 420) of a portion of the ear (e.g., the pinna) from the sensor array 420. The displacement of the portion of the ear is at least in part due to the calibration signal.

The sound pressure estimation module 480 uses a model to estimate the sound pressure at an entrance to the ear canal. The model may be configured to take, as an input, measured displacement information of the portion of the ear, and accordingly output an estimated sound pressure at the entrance to the ear canal. In some embodiments, the model is configured to factor in a geometry of the user's ear (e.g., measurements of features of the user's ear) when outputting an estimated sound pressure at the entrance to the ear canal. The geometry of the user's ear may be determined from an image and/or video of the user. The model may be, for example, a machine-learned model, such as a convolutional neural network, a linear model, a numerical simulation, or some combination thereof. The model may be trained and/or built on a dataset comprising data from a plurality of other users. The data correlates, for each of the plurality of other users, measured displacement information of a portion of an ear with a sound pressure at an entrance to an ear canal of the ear (e.g., measured by a binaural microphone). In some embodiments, the model may correlate the displacement information of portions of users' ears with the sound pressure at the entrance to the ear canal based on the following equations.

p= [symbol] (a) (1)

In equation (1), shown above, p represents sound pressure, a represents acceleration, and F represents a functional mapping between p and a. If there is a high coherence between p and a in the time domain or P (e.g., the complex frequency response of p) and A (e.g., the complex frequency response of a) in the frequency domain, then the model assumes a strong linear relationship between acceleration and sound pressure. If p is considered to be a time-invariant function of a, then p can be described in terms of a by:

p(t)=a(t)*h(t) (2)

which describes time domain convolution, or:

P(f)=A(f)H(f) (3)

Equation (3) describes spectral multiplication in the frequency domain, where either h(t) or H(f) characterize a transfer function between outer ear vibration and corresponding sound pressure. Considering a linear, time invariant (LTI) relationship between outer ear acceleration a and at the entrance to the ear canal sound pressure p, then pressure at the entrance to the ear canal can be calibrated by calibrating the right-hand side of Equations (2) and (3).

The sound pressure estimation module 280 also distinguishes between displacement of the pinna due to the audio content presented by the transducer array 410 and displaced caused by other noise. The sound pressure estimation module 280 uses a correlation model to measure correlation between audio content output by the transducer array 410 and displacement measured by the displacement sensors of the sensor array 420. A high correlation may indicate that the displacement is largely due to the audio content presented by the transducer array 410.

The sound filter module 490 generates one or more sound filters for the user based on the estimated sound pressure at the entrance to the ear canal. The estimated sound pressure at the entrance to the ear canal indicates how audio content is perceived by the user at the entrance to the ear canal, and the sound filter module 490 generates the sound filters to adjust audio content accordingly. Examples of sound filters include low pass filters, high pass filters, bandpass filters, and so on. When applied to audio content, the sound filters adjust the audio content to improve the user's auditory experience. For example, the user may perceive the adjusted audio content as filtered, augmented, amplified, attenuated, or some combination thereof. In some embodiments, the sound filters result in adjusted audio content that has a target magnitude frequency response (e.g., a flat frequency response). In other embodiments, the sound filters may target a specific range of frequencies, helping users with hearing loss in those frequency ranges hear better. After adjusting the audio content using the sound filters, the sound filter module 490 instructs the transducer array 410 to present the adjusted audio content to the user. In some embodiments, the user provides feedback on the adjusted audio content to the audio system 400, which may be incorporated into the dataset that the sound pressure estimation module 480 uses to train and/or build the model.

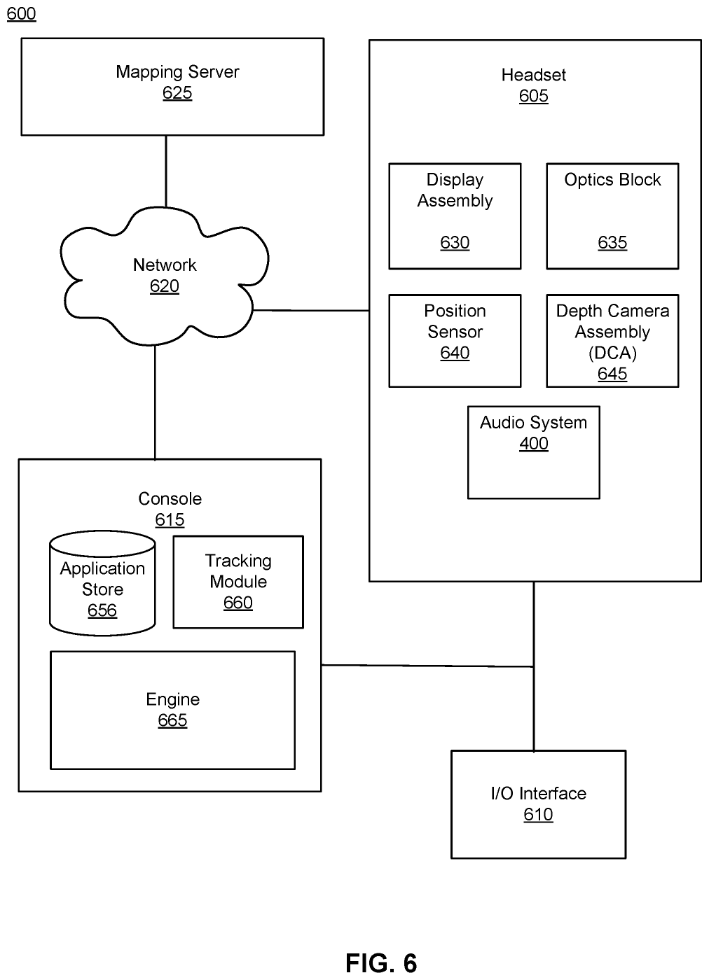

In some embodiments, the audio system 300 may spatialize the audio content using the sound filters, such that the audio content appears to originate from a target region within the local area. The sound filter module 490 may use HRTFs and/or acoustic parameters to generate the sound filters. The acoustic parameters describe acoustic properties of the local area. The acoustic parameters may include, e.g., a reverberation time, a reverberation level, a room impulse response, etc. In some embodiments, the sound filter module 490 calculates one or more of the acoustic parameters. In some embodiments, the sound filter module 490 requests the acoustic parameters from a mapping server (e.g., as described below with regard to FIG. 6).

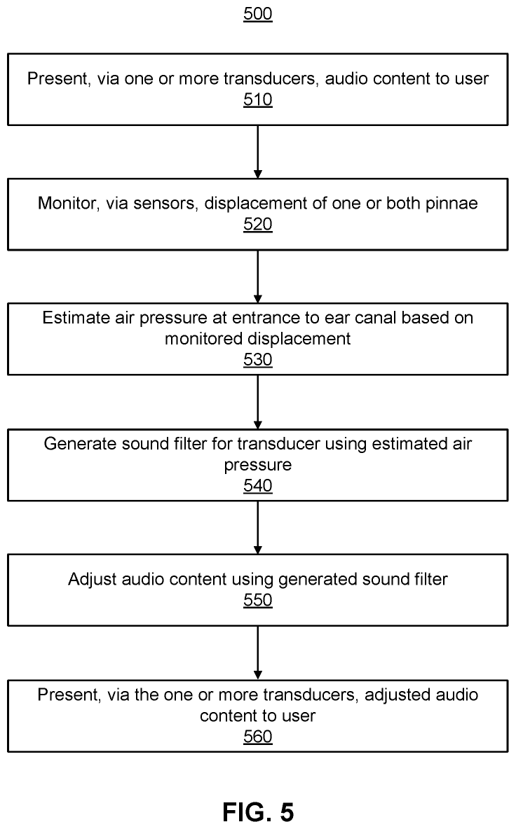

FIG. 5 is a flowchart of a process 500 for calibrating a virtual microphone, in accordance with one or more embodiments. The process 500 may be performed by components of an audio system (e.g., audio system 400). In some embodiments, the audio system is a component of a headset (e.g., the headset 205) configured to calibrate, by performing the process 500, a virtual microphone at an entrance to an ear canal of an ear of the user. In some embodiments, the audio system performs the process 500 for one or both ears of the user. Other entities may perform some or all of the steps in FIG. 5 in other embodiments. Embodiments may include different and/or additional steps, or perform the steps in different orders.

The audio system presents 510, via one or more transducers (e.g., transducers of the transducer array 410), audio content to a user. The transducers may generate the audio content based on instructions from a controller of the audio system 400 (e.g., the controller 430). The audio content may be a calibration signal. The transducers may be air conduction transducers (e.g., the air conduction transducers 180), tissue conduction transducers (e.g., the tissue conduction transducers 170), or some combination thereof.

The audio system monitors 520, via one or more sensors (e.g., sensors of the sensor array 420), displacement of a pinna (e.g., the pinna 210) of one or both ears of the user. The displacement of one or both pinnae may be in part due to vibration caused by the audio content. In some embodiments, the sensors monitoring displacement of the one or both pinnae may be integrated with and/or coupled to one or more transducers of the audio system. For example, for a given pinna, the sensors may monitor displacement of the pinna caused by a cartilage conduction transducer coupled to the pinna. One or more of the sensors may be displacement sensors (e.g., the displacement sensor 240) and/or an optical microphone.

The audio system estimates 530 sound pressure at an entrance to an ear canal of the ear (e.g., the entrance to the ear canal 215) based on the monitored displacement. For example, the audio system may provide the monitored displacement as input to a model configured to output the estimated sound pressure at the entrance to the ear canal. Based on the estimated sound pressure at the entrance to the ear canal, the audio system characterizes how audio content is perceived at the entrance to the ear canal and thereby calibrates a virtual microphone at the entrance to the ear canal. In some embodiments, the audio system estimates the sound pressure at entrances to both of the ear canals.

The audio system generates 540 one or more sound filters for the transducer based on the estimated sound pressure(s). The sound filters may amplify, attenuate, and/or augment certain frequencies. In some embodiments, the sound filters are configured to spatialize sound from the local area detected by the sensors of the audio system.

The audio system adjusts 550 audio content using the generated sound filters. In some embodiments, adjusting the audio content using the generated sound filters includes applying a gain, filtering out certain frequencies, and so on. In some embodiments, the audio content that is adjusted is sound from the local area. In other embodiments, the audio content that is adjusted is configured to be a component of an artificial reality and/or mixed reality experience.

The audio system presents 560, via the one or more transducers, the adjusted audio content to the user. The adjusted audio content may result in an improved auditory experience for the user. For example, the adjusted audio content may preserve spatial cues, amplify certain frequencies for hearing impaired users, augment sound from a local area surrounding the user for artificial reality and/or mixed reality applications, and so on.

### Artificial Reality System Environment

FIG. 6 is a block diagram of an example artificial reality system environment 600, in accordance with one or more embodiments. The system 600 may operate in an artificial reality environment (e.g., a virtual reality environment, an augmented reality environment, a mixed reality environment, or some combination thereof). The system 600 shown by FIG. 6 includes a headset 605, an input/output (I/O) interface 610 that is coupled to a console 615, the network 620, and the mapping server 625. In some embodiments, the headset 605 may be the headset 100 of FIG. 1A or the headset 105 of FIG. 1B, and configured to calibrate a virtual microphone at an entrance to an ear canal of an ear of a user.

While FIG. 6 shows an example system 600 including one headset 605 and one I/O interface 610, in other embodiments any number of these components may be included in the system 600. For example, there may be multiple headsets each having an associated I/O interface 610, with each headset and I/O interface 610 communicating with the console 615. In alternative configurations, different and/or additional components may be included in the system 600. Additionally, functionality described in conjunction with one or more of the components shown in FIG. 6 may be distributed among the components in a different manner than described in conjunction with FIG. 6 in some embodiments. For example, some or all of the functionality of the console 615 may be provided by the headset 605.

The headset 605 includes the display assembly 630, an optics block 635, one or more position sensors 640, and the DCA 645. Some embodiments of headset 605 have different components than those described in conjunction with FIG. 6. Additionally, the functionality provided by various components described in conjunction with FIG. 6 may be differently distributed among the components of the headset 605 in other embodiments, or be captured in separate assemblies remote from the headset 605.

The display assembly 630 displays content to the user in accordance with data received from the console 615. The display assembly 630 displays the content using one or more display elements (e.g., the display elements 120). A display element may be, e.g., an electronic display. In various embodiments, the display assembly 630 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 635.

The optics block 635 may magnify image light received from the electronic display, corrects optical errors associated with the image light, and presents the corrected image light to one or both eyeboxes of the headset 605. In various embodiments, the optics block 635 includes one or more optical elements. Example optical elements included in the optics block 635 include: an aperture, a Fresnel lens, a convex lens, a concave lens, a filter, a reflecting surface, or any other suitable optical element that affects image light. Moreover, the optics block 635 may include combinations of different optical elements. In some embodiments, one or more of the optical elements in the optics block 635 may have one or more coatings, such as partially reflective or anti-reflective coatings.

Magnification and focusing of the image light by the optics block 635 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 635 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 635 corrects the distortion when it receives image light from the electronic display generated based on the content.

The position sensor 640 is an electronic device that generates data indicating a position of the headset 605. The position sensor 640 generates one or more measurement signals in response to motion of the headset 605. The position sensor 190 is an embodiment of the position sensor 640. Examples of a position sensor 640 include: one or more IMUS, one or more accelerometers, one or more gyroscopes, one or more magnetometers, another suitable type of sensor that detects motion, or some combination thereof. The position sensor 640 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 605 from the sampled data. For example, the IMU integrates the measurement signals received from the accelerometers over time to estimate a velocity vector and integrates the velocity vector over time to determine an estimated position of a reference point on the headset 605. The reference point is a point that may be used to describe the position of the headset 605. While the reference point may generally be defined as a point in space, however, in practice the reference point is defined as a point within the headset 605.

The DCA 645 generates depth information for a portion of the local area. The DCA includes one or more imaging devices and a DCA controller. The DCA 645 may also include an illuminator. Operation and structure of the DCA 645 is described above with regard to FIG. 1A.

The audio system 400 provides audio content to a user of the headset 605. The audio system 400 calibrates a virtual microphone positioned at an entrance to an ear canal of a user's ear and adjusts audio content for the user accordingly. In some embodiments, the audio system calibrates the virtual microphone using a machine-learned model. The audio system provides, as input, displacement information about a portion of the user's ear to the model, which outputs an estimated sound pressure at the entrance to the ear canal. Accordingly, the audio system may predict how audio content generated by a transducer array is perceived at the entrance to the ear canal. In some embodiments, the audio system calibrates a virtual microphone for each of the user's ears. As described above, with respect to FIG. 4, the audio system 400 may comprise a transducer array 410, a sensor array 420, and a controller 430. The audio system 400 may include other components than those described herein.

In addition to calibration a virtual microphone at the entrance to an ear canal of the user, the audio system 400 may perform other functions. In some embodiments, the audio system 400 may request acoustic parameters from the mapping server 625 over the network 620. The acoustic parameters describe one or more acoustic properties (e.g., room impulse response, a reverberation time, a reverberation level, etc.) of the local area. The audio system 400 may provide information describing at least a portion of the local area from e.g., the DCA 645 and/or location information for the headset 605 from the position sensor 640. The audio system 400 may generate one or more sound filters using one or more of the acoustic parameters received from the mapping server 625, and use the sound filters to provide audio content to the user.

The I/O interface 610 is a device that allows a user to send action requests and receive responses from the console 615. An action request is a request to perform a particular action. For example, an action request may be an instruction to start or end capture of image or video data, or an instruction to perform a particular action within an application. The I/O interface 610 may include one or more input devices. Example input devices include: a keyboard, a mouse, a game controller, or any other suitable device for receiving action requests and communicating the action requests to the console 615. An action request received by the I/O interface 610 is communicated to the console 615, which performs an action corresponding to the action request. In some embodiments, the I/O interface 610 includes an IMU that captures calibration data indicating an estimated position of the I/O interface 610 relative to an initial position of the I/O interface 610. In some embodiments, the I/O interface 610 may provide haptic feedback to the user in accordance with instructions received from the console 615. For example, haptic feedback is provided when an action request is received, or the console 615 communicates instructions to the I/O interface 610 causing the I/O interface 610 to generate haptic feedback when the console 615 performs an action.

The console 615 provides content to the headset 605 for processing in accordance with information received from one or more of: the DCA 645, the headset 605, and the I/O interface 610. In the example shown in FIG. 6, the console 615 includes an application store 655, a tracking module 660, and an engine 665. Some embodiments of the console 615 have different modules or components than those described in conjunction with FIG. 6. Similarly, the functions further described below may be distributed among components of the console 615 in a different manner than described in conjunction with FIG. 6. In some embodiments, the functionality discussed herein with respect to the console 615 may be implemented in the headset 605, or a remote system.

The application store 655 stores one or more applications for execution by the console 615. An application is a group of instructions, that when executed by a processor, generates content for presentation to the user. Content generated by an application may be in response to inputs received from the user via movement of the headset 605 or the I/O interface 610. Examples of applications include: gaming applications, conferencing applications, video playback applications, or other suitable applications.

The tracking module 660 tracks movements of the headset 605 or of the I/O interface 610 using information from the DCA 645, the one or more position sensors 640, or some combination thereof. For example, the tracking module 660 determines a position of a reference point of the headset 605 in a mapping of a local area based on information from the headset 605. The tracking module 660 may also determine positions of an object or virtual object. Additionally, in some embodiments, the tracking module 660 may use portions of data indicating a position of the headset 605 from the position sensor 640 as well as representations of the local area from the DCA 645 to predict a future location of the headset 605. The tracking module 660 provides the estimated or predicted future position of the headset 605 or the I/O interface 610 to the engine 665.

The engine 665 executes applications and receives position information, acceleration information, velocity information, predicted future positions, or some combination thereof, of the headset 605 from the tracking module 660. Based on the received information, the engine 665 determines content to provide to the headset 605 for presentation to the user. For example, if the received information indicates that the user has looked to the left, the engine 665 generates content for the headset 605 that mirrors the user's movement in a virtual local area or in a local area augmenting the local area with additional content. Additionally, the engine 665 performs an action within an application executing on the console 615 in response to an action request received from the I/O interface 610 and provides feedback to the user that the action was performed. The provided feedback may be visual or audible feedback via the headset 605 or haptic feedback via the I/O interface 610.

The network 620 couples the headset 605 and/or the console 615 to the mapping server 625. The network 620 may include any combination of local area and/or wide area networks using both wireless and/or wired communication systems. For example, the network 620 may include the Internet, as well as mobile telephone networks. In one embodiment, the network 620 uses standard communications technologies and/or protocols. Hence, the network 620 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 620 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 620 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 625 may include a database that stores a virtual model describing a plurality of spaces, wherein one location in the virtual model corresponds to a current configuration of a local area of the headset 605. The mapping server 625 receives, from the headset 605 via the network 620, information describing at least a portion of the local area and/or location information for the local area. The user may adjust privacy settings to allow or prevent the headset 605 from transmitting information to the mapping server 625. The mapping server 625 determines, based on the received information and/or location information, a location in the virtual model that is associated with the local area of the headset 605. The mapping server 625 determines (e.g., retrieves) one or more acoustic parameters associated with the local area, based in part on the determined location in the virtual model and any acoustic parameters associated with the determined location. The mapping server 625 may transmit the location of the local area and any values of acoustic parameters associated with the local area to the headset 605.

One or more components of system 600 may contain a privacy module that stores one or more privacy settings for user data elements. The user data elements describe the user or the headset 605. For example, the user data elements may describe a physical characteristic of the user, an action performed by the user, a location of the user of the headset 605, a location of the headset 605, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 600 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
presenting, via a transducer, audio content to a user;
monitoring, via one or more sensors, displacement of a portion of a pinna of the user, the displacement caused in part by the presented audio content;
estimating a sound pressure at an entrance to an ear canal of the user based on the monitored displacement of the portion of the pinna;
generating a sound filter for the transducer using the estimated sound pressure at the entrance to the ear canal;
adjusting audio content using the generated filter; and
presenting, via the transducer, the adjusted audio content to the user.

2. The method of claim 1, wherein the transducer is a cartilage conduction transducer configured to present the audio content.

3. The method of claim 2, wherein one of the one or more sensors is the cartilage conduction transducer.

4. The method of claim 3, further comprising:
monitoring the displacement of the portion of the pinna of the user by measuring a preload of the cartilage conduction transducer.

5. The method of claim 1, wherein the one or more sensors comprise at least one of:
acceleration sensors and optical displacement sensors.

6. The method of claim 1, wherein the transducer is a speaker configured to present the audio content to the user via air conduction.

7. The method of claim 1, wherein estimating the sound pressure at the entrance to the ear canal comprises:
providing, as input, the monitored displacement of the portion of the pinna to a model, the model configured to output sound pressure at the entrance to the ear canal based on displacement of the pinna.

8. The method of claim 7, wherein the model comprises at least one of: a convolutional neural network, a linear model, and a numerical simulation.

9. The method of claim 7, wherein the model is configured to receive, as input, a geometry of the ear of the user, the geometry including measurements determined from one or more images of the ear of the user.

10. The method of claim 1, wherein the adjusted audio content has a target magnitude frequency response.

11. An audio system comprising:
a transducer configured to present audio content to a user;
one or more sensors configured to measure displacement of a portion of a pinna of the user, the displacement caused by the presented audio content; and
a controller configured to:
estimate a sound pressure at an entrance to an ear canal of the user based on the monitored displacement of the portion of the pinna;
generate a sound filter for the transducer using the estimated sound pressure at the entrance to the ear canal;
adjust audio content using the generated filter; and
instruct the transducer to present the adjusted audio content to the user.

12. The audio system of claim 11, wherein the transducer is a cartilage conduction transducer configured to present audio content.

13. The audio system of claim 12, wherein one of the one or more sensors is the cartilage conduction transducer.

14. The audio system of claim 13, wherein the controller is further configured to monitor the displacement of the portion of the pinna of the user by measuring a preload of the cartilage conduction transducer.

15. The audio system of claim 11, wherein the one or more sensors comprise at least one of: acceleration sensors and optical displacement sensors.

16. The audio system of claim 11, wherein the transducer is a speaker configured to present the audio content to the user via air conduction.

17. The audio system of claim 11, wherein estimating the sound pressure at the entrance to the ear canal comprises the controller being further configured to:
provide, as input, the monitored displacement of the portion of the pinna to a model, the model configured to output sound pressure at the entrance to the ear canal based on displacement of the pinna.

18. The audio system of claim 17, wherein the model comprises at least one of: a convolutional neural network, a linear model, and a numerical simulation.

19. The audio system of claim 17, wherein the model is configured to receive, as input, a geometry of the ear of the user, the geometry including measurements determined from one or more images of the ear of the user.

20. The audio system of claim 11, wherein the adjusted audio content has a target magnitude frequency response.
